(19) United States
(12) Patent Application Publication
(10) Pub. No.: US 2007/0264356 A1
(43) Pub. Date: Nov. 15, 2007

(54) Process for the preparation of a ready-to-use disinfectant

(76) Inventor: Kelly Ann Ames, Suffolk (GB)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/787,731

(22) Filed: Apr. 17, 2007

Related U.S. Application Data
(60) Provisional application No. 60/798,907, filed on May 9, 2006.

(51) Int. Cl. A01N 31/02; A01N 37/00; A01P 1/00

(52) U.S. Cl. 424/616; 424/613; 514/557

(57) ABSTRACT

A process for the preparation of an aqueous ready-to-use disinfectant composition comprising the following successive steps:
1) (a) providing an aqueous preparation A comprising at least one peracid; and (b) providing a preparation B comprising at least one organic compound capable of showing fluorescence on UV irradiation; and
2) mixing the preparations A and B and, optionally, water,
wherein the composition of the preparations A and B and the mixing ratio used in step 2) is selected in such a manner that the resultant aqueous ready-to-use disinfectant composition comprises
0.005 to 5 wt. % of the at least one peracid, and
0.0001 to 3 wt. % of the at least one organic compound capable of showing fluorescence on UV irradiation.

### FIELD OF THE INVENTION

The invention relates to a process for the preparation of a ready-to-use disinfectant of the aqueous peracid (peroxycarboxylic acid) type, to the ready-to-use disinfectant and to a disinfection process making use of the ready-to-use disinfectant.

### BACKGROUND OF THE INVENTION

The term “ready-to-use disinfectant” used in the description and the claims means the disinfectant at a concentration at which the disinfectant is applied by the user.

Disinfectants containing compounds that fluoresce on UV (ultraviolet) irradiation as a monitoring means are known from WO 98/21569 and WO 98/20094. Such disinfectants allow for determining whether they have been used correctly in terms of completeness of application, i.e., whether they have or have not reached all parts of a substrate surface to be disinfected during application by simply irradiating the substrate surface with UV light during or after application of the disinfectant and observing the fluorescence by the human eye.

It would be desirable to use the monitoring principle described in the preceding paragraph also in disinfectants of the aqueous peracid type.

However, the simple addition of a compound capable of showing fluorescence on UV irradiation to disinfectants of the aqueous peracid type does not yield disinfectants with a satisfactory and sufficiently sustainable fluorescence property. The compounds capable of showing fluorescence on UV irradiation undergo fast decomposition or chemical change in the presence of the aggressive biocides contained in such disinfectants, for example, a peracid, a combination of peracid and hydrogen peroxide or a combination of peracid, the corresponding carboxylic acid and hydrogen peroxide; i.e., the disinfectant loses its fluorescence property rapidly which is unacceptable from the user's standpoint.

### SUMMARY OF THE INVENTION

It has now been found that it is possible to prepare disinfectants of the aqueous peracid type having the required sustainable fluorescence property, i.e., a fluorescence which is stable over the working life of the disinfectant, if a first aqueous composition comprising peracid is mixed with a second composition comprising an organic compound capable of showing fluorescence on UV irradiation and, preferably, also a surfactant.

Accordingly, the present invention is related to a process for the preparation of an aqueous ready-to-use disinfectant composition comprising the following successive steps:

1) (a) providing an aqueous preparation A comprising at least one peracid; and (b) providing a preparation B comprising at least one organic compound capable of showing fluorescence on UV irradiation and, preferably, at least one surfactant C; and

2) mixing the preparations A and B and, optionally, water,

wherein the composition of the preparations A and B and the mixing ratio used in step 2) is selected in such a manner that the resultant aqueous ready-to-use disinfectant composition comprises

0.005 to 5 wt. %, preferably 0.01 to 0.5 wt. %, of the at least one peracid,

0.0001 to 3 wt. % of the at least one organic compound capable of showing fluorescence on UV irradiation and,

preferably, 0.001 to 30 wt. % of the at least one surfactant C.

### DETAILED DESCRIPTION OF THE INVENTION

In a first preferred embodiment the process according to the invention is a process for the preparation of an aqueous ready-to-use disinfectant composition comprising the following successive steps:

1) (a) providing an aqueous preparation A1 comprising at least one peracid prepared by the addition of the at least one peracid or of a precursor for the at least one peracid to water; and (b) providing a preparation B comprising at least one organic compound capable of showing fluorescence on UV irradiation and, preferably, at least one surfactant C;

2) mixing the preparations A1 and B and, optionally, water, wherein the composition of the preparations A1 and B and the mixing ratio used in step 2) is selected in such a manner that the resultant aqueous ready-to-use disinfectant composition comprises
0.005 to 1 wt. %, preferably 0.01 to 0.5 wt. % of the at least one peracid, 0.0001 to 3 wt. % of the at least one organic compound capable of showing fluorescence on UV irradiation and, preferably, 0.001 to 30 wt. % of the at least one surfactant C.

In a second preferred embodiment the process according to the invention is a process for the preparation of an aqueous ready-to-use disinfectant composition comprising the following successive steps:

1) (a) providing an aqueous preparation A2 comprising hydrogen peroxide and at least one peracid prepared by in-situ generation of the at least one peracid from at least one precursor and at least one peroxide source; and (b) providing a preparation B comprising at least one organic compound capable of showing fluorescence on UV irradiation and, preferably, at least one surfactant C;

2) mixing the preparations A2 and B and, optionally, water,

wherein the composition of the preparations A2 and B and the mixing ratio used in step 2) is selected in such a manner that the resultant aqueous ready-to-use disinfectant composition comprises
0.005 to 5 wt. %, preferably 0.05 to 0.1 wt. % of the at least one peracid, 0.0001 to 3 wt. % of the at least one organic compound capable of showing fluorescence on UV irradiation and, preferably, 0.001 to 30 wt. % of the at least one surfactant C.

The ready-to-use disinfectant composition prepared according to the second preferred embodiment of the process according to the invention also comprises hydrogen peroxide, for example, in a proportion of 0.001 to 6 wt. %, preferably 0.05 to 0.1 wt. %.

In a third preferred embodiment the process according to the invention is a process for the preparation of an aqueous ready-to-use disinfectant composition of the so-called aqueous equilibrium peracid type, i.e., disinfectants on the basis of an aqueous composition, preferably an aqueous solution, comprising as essential constituents hydrogen peroxide, at least one peracid and the corresponding one or more carboxylic acids present in a chemical equilibrium. The term “the corresponding one or more carboxylic acids” means the carboxylic acid(s) corresponding to the one or more specified peracids. The process comprises the following successive steps:

1) (a) providing an aqueous preparation A3 comprising, in a chemical equilibrium with each other, hydrogen peroxide, at least one peracid and the corresponding at least one carboxylic acid; and (b) providing a preparation B comprising at least one organic compound capable of showing fluorescence on UV irradiation and, preferably, at least one surfactant C; and

2) mixing the preparations A3 and B and, optionally, water,

wherein the composition of the preparations A3 and B and the mixing ratio used in step 2) is selected in such a manner that the resultant aqueous ready-to-use disinfectant composition comprises
0.005 to 1 wt. %, preferably 0.01 to 0.5 wt. % of the at least one peracid,
0.006 to 1.2 wt. %, preferably 0.012 to 0.6 wt. % of the corresponding at least one carboxylic acid,
0.025 to 5 wt. %, preferably 0.05 to 2.5 wt. % of hydrogen peroxide,
0.0001 to 3 wt. % of the at least one organic compound capable of showing fluorescence on UV irradiation and, preferably,
0.001 to 30 wt. % of the at least one surfactant C.

The peracids that may be used in the process of the invention include C1-C9 peracids, the C1-C3 peracids being preferred, peracetic acid being most preferred. Examples of suitable C1-C9 peracids include performic acid, peracetic acid, perpropionic acid, pernonanoic acid and halogen-substituted peracetic acids, such as, for example, monochloroperacetic acid, dichloroperacetic acid, trichloroperacetic acid and trifluoroperacetic acid; the halogen-free peracids being preferred not least because of environmentally friendliness and biodegradability after the ready-to-use disinfectant's use. Accordingly, formic acid, acetic acid, propionic acid, nonanoic acid and halogen-substituted acetic acids, such as, for example, monochloroacetic acid, dichloroacetic acid, trichloroacetic acid and trifluoroacetic acid are examples of the corresponding carboxylic acids.

In step 1) of the process according to the invention an aqueous preparation A and a preparation B are provided.

In the first preferred embodiment of the process according to the invention the aqueous preparations A are aqueous preparations of the A1 type comprising at least one peracid prepared by the addition of the at least one, particularly, solid peracid as such or in the form of a peracid precursor to water. Preferably, the aqueous preparations A1 are aqueous solutions. Examples of suitable peracid (precursors) include magnesium monoperoxyphthalate hexahydrate, diperoxydodecanoic acid and phthalimidoperoxycaproic acid. It is understood that the aqueous preparations A1 may also comprise hydrogen peroxide and the carboxylic acid(s) corresponding to the peracid(s) as a result of the peracid(s) equilibration and/or decomposition behavior over time.

In the second preferred embodiment of the process according to the invention, the aqueous preparations A are aqueous preparations, in particular aqueous solutions, of the A2 type comprising at least one peracid and hydrogen peroxide prepared by the, optionally catalyzed, in-situ generation of the peracid(s) from at least one precursor, such as acylating agents, for example, esters or amides of carboxylic acids and at least one source of peroxide. Examples of typical acylating agents useful as precursors are sodium nonanoyloxybenzenesulfonate (SNOBS) or tetraacetyl ethylene diamine (TAED). The source of peroxide is typically hydrogen peroxide itself and/or a hydrogen peroxide source, for example, inorganic per-salts, such as perborate, percarbonate, perphosphate, persulfate, and persilicate salts. The in-situ generation of peracid is known to the person skilled in the art, for example, from WO 2006/016145. It is understood that the aqueous preparations A2 may also comprise the carboxylic acid(s) corresponding to the peracid(s) as a result of the peracid(s) equilibration and/or decomposition behavior over time.

In the third preferred embodiment of the process according to the invention the aqueous preparations A are aqueous preparations of the A3 type in the form of an aqueous equilibrium peracid solution comprising hydrogen peroxide, at least one peracid and the corresponding at least one carboxylic acid.

Aqueous equilibrium peracid solutions and the preparation thereof are well-known, for example, from U.S. Pat. No. 5,489,706, WO 94/20424, U.S. Pat. No. 5,545,374 and U.S. Pat. No. 5,965,033. The aqueous equilibrium peracid solutions may be prepared by mixing a carboxylic acid with hydrogen peroxide and letting the mixture react in aqueous medium. Preferably the preparation happens by mixing hydrogen peroxide to an aqueous solution of the carboxylic acid and letting the mixture react under the catalytic action of a strong acid, such as, for example, sulfuric acid at temperatures of less than 25° C. After the chemical equilibrium has been reached the aqueous equilibrium peracid solution obtained can be stored at temperatures preferably not exceeding 25° C., for example, between 10 and 25° C.

The composition of the aqueous preparations A3 can vary in wide ranges, depending amongst others on the ratio chosen between hydrogen peroxide, water and the at least one carboxylic acid for the preparation of the respective aqueous equilibrium peracid solutions. For example, the aqueous preparations A3 may exhibit a weight ratio of 3 to 10 pbw (parts by weight) of hydrogen peroxide: 0.15 to 2.5 pbw of the at least one peracid: 1 pbw of the corresponding at least one carboxylic acid. Preferred aqueous preparations A3 comprise, for example, 40 to 80 wt. % of water, 14 to 50 wt. % of hydrogen peroxide, 1 to 17 wt. % of the at least one peracid and 0.1 to 17 wt. % of the corresponding at least one carboxylic acid. One example of a commercially available aqueous equilibrium peracetic acid solution that can be used as an aqueous preparation A3 is the product Hyperox® from DuPont Animal Health Solutions which comprises about 60 wt. % water, 25 wt. % hydrogen peroxide, 6 wt. % acetic acid and 5 wt. % peracetic acid.

The aqueous preparations A3 may comprise small amounts of strong acid, for example, up to 3 wt. % of a mineral acid, such as, sulfuric acid, which may have served as a catalyst during the preparation of the aqueous equilibrium peracid solution.

The aqueous preparations A may comprise one or more additives. Examples of possible additives are those conventional in disinfectants of the aqueous peracid type, including peroxide decomposition stabilizers, such as, transition metal sequestering (complexing, chelating) agents; surfactants; water hardness stabilizers, for example, such compounds as are mentioned in U.S. Pat. No. 6,254,801 B1; buffers; pH-adjusting components, such as alkaline inorganic salts; viscosity modifiers, for example, thickeners; co-biocides; corrosion inhibitors; builders; catalysts; fragrances and dyes.

The preparations B comprise at least one organic compound capable of showing fluorescence on UV irradiation, preferably in combination with at least one surfactant C. The preparations B may be non-aqueous. However, preferably they are aqueous compositions, for example, solutions, dispersions or emulsions; aqueous solutions B being particularly preferred. If the preparations B do not comprise at least one surfactant C, they are aqueous solutions of the at least one organic compound capable of showing fluorescence on UV irradiation. If the preparations B are non-aqueous, they comprise at least the at least one organic compound capable of showing fluorescence on UV irradiation and the at least one surfactant C. Preferred aqueous preparations B comprise, for example, 40 to 99 wt. % of water, 1 to 50 wt. % of at least one surfactant C and 0.001 to 10 wt. % of at least one organic compound capable of showing fluorescence on UV irradiation.

The at least one organic compound capable of showing fluorescence on UV irradiation present in the preparations B may be selected from various classes of organic substances. The term “organic compound capable of showing fluorescence on UV irradiation” means an organic compound that is capable of generating intense fluorescence under UV irradiation; it shall not be understood to exclude such organic compounds that comprise an inorganic element or moiety in the molecule. For example, salts consisting of an organic ion and an inorganic counterion are expressly not excluded. The at least one organic compound capable of showing fluorescence on UV irradiation may be selected, for example, from among those organic substances conventional as optical brighteners (fluorescent whitening agents) in detergents for laundry applications. An example of a preferred organic compound capable of showing fluorescence on UV irradiation that can be used in preparation B is sodium distyryl biphenylsulfonate which is commercially available as Tinopal® CBS-X from Ciba.

As already mentioned, the preparation B preferably comprises at least one surfactant C. In general the aqueous preparations A do not comprise surfactants C, although they may optionally comprise other surfactants which are different from the at least one surfactant C. However, in the preferred case of preparation B, which comprises at least one surfactant C, the at least one surfactant C may be present in the aqueous preparation A as well, although it is preferred that only preparation B comprises the at least one surfactant C. The at least one surfactant C may be selected from conventional anionic, nonionic and/or amphoteric surfactants. The at least one surfactant C enables for a more homogenous fluorescence on UV irradiation and for avoiding ambiguous monitoring results under UV irradiation. It is preferred to use so-called high-foaming surfactants as surfactants C. To elucidate the high-foaming nature of a surfactant C the following controlled test is performed: A control solution is prepared by adding such amount of Hostapure SAS 60 (sodium C14-C17 secondary alkylsulphonate from Clariant) to a surfactant-free aqueous equilibrium peracid solution comprising 0.25 wt. % hydrogen peroxide, 0.06 wt. % acetic acid and 0.05 wt. % peracetic acid that a concentration of 0.006 wt. % of sodium C14-C17 secondary alkylsulphonate, calculated as 100% substance, in the control solution is achieved. 30 ml of this control solution is added to a 100 ml measuring cylinder I and stoppered. The measuring cylinder I is inverted 10 times and the volume of foam is measured immediately, after five minutes, and after one hour. In a second experiment 0.03 wt. % of surfactant C is added to the control solution and 30 ml of the resulting mixture are added to a measuring cylinder II similar to measuring cylinder I. The stoppered measuring cylinder II is inverted 10 times and the volume of foam is measured immediately, after five minutes, and after one hour. Surfactants C are classified as surfactants of the high-foaming type if the foam volume in measuring cylinder II is at least 100% higher than the foam volume in measuring cylinder I, the foam volume in each case being measured one hour after the 10 times inversion. Examples of useful high-foaming surfactants C comprise Berol® DGR-81 from Akzo Nobel (95 wt. % active substance: mixture of a C9-C11 alcohol ethoxylate and an alkyl glucoside) and Mackam® CBS-50G from McIntyre Group, Ltd. (active substance cocamidopropyl hydroxysultaine, 40 wt. %).

The preparations B may comprise one or more further additives. Examples of further possible additives are transition metal sequestering agents, corrosion inhibitors, stabilizers, viscosity modifiers, builders, dyes and fragrances.

In step 2) of the process according to the invention the preparations A and B and, optionally but preferably, water, are mixed, for example, under stirring.

Not least because of transportation, storage and handling reasons, it is preferred to supply the user (the person practising the process according to the invention as well as applying the resultant ready-to-use disinfectant composition) with the precursor materials for the preparation of aqueous preparations A1 or A2 to be performed at the users' premises. In case of aqueous preparations A3 it is preferred to supply the user with aqueous concentrates. For the same reasons, preparation B is preferably supplied to the user as a non-aqueous or aqueous concentrate.

In principle any mixing sequence is possible. To this end, the composition of both of the preparations A and B and the relative ratio thereof needs to be selected accordingly. If at least one of the preparations A and B is a concentrate, the proportion of water to be mixed with the preparations A and/or B needs to be selected accordingly as well. In principle, it is also possible to mix concentrates of preparations A and B and then to dilute with water. If preparation A is a concentrate with a high peracid content of, for example, above 1 to 5 wt. %, it is expedient not to delay the water dilution step and to perform the dilution with water soon or preferably immediately, for example, within 60 minutes after having mixed preparations A and B. However, to achieve best results in terms of sustainability of the fluorescence property, it is preferred to contact the preparations A and B under conditions that allow for the at least one organic compound capable of showing fluorescence on UV irradiation to come into contact with the peracid only at a certain minimum degree of dilution. Preferably the concentration of the at least one peracid is less than 3 wt. % in the aqueous preparation A prior to contacting it with the at least one organic compound capable of showing fluorescence on UV irradiation, i.e., prior to mixing it with the concentrated or already aqueously diluted preparation B; here, it is self-explanatory that the resultant ready-to-use disinfectant composition will have a content of the at least one peracid of less than 3 wt. %, for example, of 0.005 to 1 wt. %. In other words, it is preferred to predilute at least aqueous preparation A with water prior to mixing it with preparation B. The preparations A and B may be prediluted with water to exactly such degree that on mixing them the ready-to-use disinfectant is obtained with the desired composition and without a need of adjusting its concentration by further dilution with water. An also preferred mixing alternative is the simultaneous addition of relatively concentrated preparations A and B in the appropriate ratio into water while stirring the mixture thus ensuring the preferred effect of dilution directly from the start of dosing the preparations A and B into the water.

If step 2) of the process according to the invention is performed in the preferred manner, i.e., including the use of water for dilution purposes, it is preferred to use pure, deionized or distilled water. It is also possible to use tap water, but in this case it is recommended that at least one of the preparations A and B comprises at least one transition metal sequestering agent.

Furthermore, to achieve best results in terms of sustainability of the fluorescence property, it is preferred to use, i.e., to apply the ready-to-use disinfectant composition obtained in step 2) of the process according to the invention within 48 hours, preferably within 24 hours, of its preparation, i.e., calculated after completion of the mixing step 2). In other words, it is preferred to store the precursor materials for the preparation of aqueous preparations A1 or A2 or the aqueous preparations A3 separate from preparations B until mixing step 2) is performed, which happens preferably no longer than 48 hours, more preferred no longer than 24 hours and most preferred just before application of the ready-to-use disinfectant.

This invention further provides a disinfection method which comprises using a ready-to-use disinfectant prepared according to the process described hereinabove. The ready-to-use disinfectant is reliably effective against a large number of germs, in particular pathogenic germs including bacteria, viruses, fungi, spores, yeasts and algae. It may be used for different disinfecting purposes, for example, in the food, milk, brewing or beverage industry; in farming, for example, cattle or poultry breeding, dairy farming, in laying batteries; in the medical or surgery sector; in sanitary hygiene. It may be used in the disinfection of water-circulating systems, but in particular, is used by applying to surfaces for surface disinfection applications, for example, the disinfection of installations; equipment; pipework; containers; bottles; sanitary objects; work surfaces; furniture; walls; floors; ceilings or complete rooms or buildings; shoes and protective clothing of staff; transportation vehicles, especially the wheels thereof. Contact of the ready-to-use disinfectant with the skin or mucous membranes should be avoided. Those skilled in the art will appreciate the need for appropriate safety use of the ready-to-use disinfectant. For the purposes of surface disinfection the ready-to-use disinfectant may be applied by various application methods which are selected dependent on the kind of surface which is to be disinfected. Application methods include fogging (spraying, atomization), wiping, brushing, dipping and rinsing to name only the most common methods. In certain cases the application of the ready-to-use disinfectant may be followed by a water-rinse after the disinfectant has taken effect; however, generally this is not the case.

Depending on the specific disinfection task to be performed the degree of dilution of the ready-to-use disinfectant will be selected at the lower, the upper or between the lower and the upper end of the concentration range of the at least one peracid.

For example, for routine disinfection preparation A may be diluted and mixed with preparation B so that the final ready-to-use disinfectant comprises 0.02 to 0.03 wt. % of peracid and 0.001 to 0.1 wt. % of organic compound capable of showing fluorescence on UV irradiation. Such ready-to-use disinfectant may be applied to a pre-cleaned surface, for example, at a rate of 300 ml/m² of surface area by conventional means, for example, using a knapsack sprayer or a pressure washer set.

For example, for fogging disinfection preparation A may be diluted and mixed with preparation B so that the final ready-to-use disinfectant comprises 0.4 to 0.6 wt. % of peracid and 0.001 to 0.1 wt. % of organic compound capable of showing fluorescence on UV irradiation. Such ready-to-use disinfectant may be applied by conventional means, for example, using a thermal fogging machine at a rate of, for example, 17 ml/m³.

For example, for equipment disinfection preparation A may be diluted and mixed with preparation B so that the final ready-to-use disinfectant comprises 0.04 to 0.06 wt. % of peracid and 0.001 to 0.1 wt. % of organic compound capable of showing fluorescence on UV irradiation. The equipment to be disinfected may be immersed in the ready-to-use disinfectant and may or may not be rinsed after removal.

During and/or after application of the ready-to-use disinfectant, preferably before the disinfectant has dried, for example, within 15 minutes, the surface to which the disinfectant has been applied may be irradiated with UV light for monitoring purposes. The UV irradiation enables the user to determine whether the disinfectant has been thoroughly applied as required by the observation of, or the lack of, fluorescence. Conventional sources of UV light in the wavelength range of 280 to 420 nm, such as, for example, optionally doped high, medium and low pressure mercury vapor lamps and gas discharge tubes, such as, for example, low pressure xenon lamps may be used for irradiation of the surfaces with UV light. Generally, the fluorescence is sufficiently bright in the daylight to be observed by the human eye. However, observation of the fluorescence may be supported by taking darkening measures.

### EXAMPLES

pbw means parts by weight.

Materials used:

Preparation A(i): Hyperox® from DuPont Animal Health Solutions (aqueous equilibrium peracetic acid solution comprising 25 wt. % hydrogen peroxide, 6 wt. % acetic acid and 5 wt. % peracetic acid).

Preparation A(ii): Proxitane® 5 from Solvay Chemicals, Inc. (aqueous equilibrium peracetic acid solution comprising 20 wt. % hydrogen peroxide, 10 wt. % acetic acid and 5 wt. % peracetic acid).

Preparation B(i): Mixture of 5.2 wt. % Tinopal® CBS-X, 5.2 wt. % Ampholak® YCE from Akzo Nobel (sodium cocopropylenediamine tripropionate), 11.3 wt. % Berol® DGR-81 and 78.3 wt. % water.

Preparation B(ii): Mixture of 4.62 wt. % Tinopal® CBS-X, 26.0 wt. % Mackam® CBS-50G and 69.38 wt. % water.

### Example 1

1 wt. % solutions of preparations A(i) or A(ii) were prepared by dilution of preparations A(i) or A(ii) with distilled water. 0.1 pbw of preparation B(i) or 0.113 pbw of preparation B(ii) were added to 100 pbw of the 1 wt. % solutions of preparations A(i) or A(ii) with stirring. Any of the four so prepared final ready-to-use disinfectants comprised 0.05 wt. % peracetic acid and 0.005 wt. % Tinopal® CBS-X.

Immediately, one hour, 24, 48, 72, 96 hours and 7 days after their preparation, the ready-to-use disinfectants were sprayed onto a non-porous black plastic surface using a spray bottle. One spray of each ready-to-use disinfectant was applied. The surface was irradiated with a mercury vapor UV lamp (maximum of the emission spectrum at 302 nm) from a distance of 20 cm. The lighting conditions of the room were bright (daylight conditions, no darkening measures were taken).

The solutions showed visually intense fluorescence on exposure to UV light even 7 days after their preparation.

### Example 2

10 pbw of preparation B(i) or 11.3 pbw of preparation B(ii) were added to 100 pbw of preparations A(i) or A(ii) under stirring. Any of the four so prepared mixtures were immediately diluted with distilled water to obtain final ready-to-use disinfectants comprising 0.05 wt. % peracetic acid and 0.005 wt. % Tinopal® CBS-X.

The ready-to-use disinfectants were tested according to the procedure described in Example 1.

The ready-to-use disinfectants showed visually intense fluorescence on exposure to UV light even 7 days after their preparation.

### Example 3

Example 2 was repeated without performing dilution with distilled water. The results of the visual assessment of the fluorescence are shown in Table 1.

### Example 4

3 wt. % solutions of preparations A(i) or A(ii) were prepared by dilution with distilled water. 10 pbw of preparation B(i) or 11.3 pbw of preparation B(ii) were added to 100 pbw of the 3 wt. % solutions of preparations A(i) or A(ii), with stirring.

The mixtures were tested according to the procedure described in Example 1. The results of the visual assessment of the fluorescence are shown in Table 1.

### Example 5

2 wt. % solutions of preparations A(i) or A(ii) were prepared by dilution with distilled water. 10 pbw of preparation B(i) or 11.3 pbw of preparation B(ii) were added to 100 pbw of the 2 wt. % solutions of preparations A(i) or A(ii), with stirring.

The mixtures were tested according to the procedure described in Example 1. The results of the visual assessment of the fluorescence are shown in Table 1.

### Example 6

10 pbw of preparation B(i) or 11.3 pbw of preparation B(ii) were added to 100 pbw of preparations A(i) or A(ii) under stirring. The four so prepared mixtures were diluted with distilled water at times of 0, 1, 6, 24, 48, and 72 hours after initial preparation. The ratio between the mixtures and the distilled water was the same as in Example 2.

Immediately after their preparation the so prepared ready-to-use disinfectants were tested according to the procedure described in Example 1. The results of the visual assessment of the fluorescence are shown in Table 1.

TABLE 1

| | | Fluorescence | Fluorescence | Fluorescence | Fluorescence |
|---|---|---|---|---|---|
| | Time | Strength | Strength | Strength | Strength |
| | (hours) | (Example 3) | (Example 4) | (Example 5) | (Example 6) |
| A(i) + B(i) | 0 | Very strong | Very strong | Very strong | Very strong |
| | 1 | Very strong | Very strong | Very strong | Very strong |
| | 6 | Very strong | Very strong | Very strong | Faint |
| | 24 | Barely visible | Barely visible | Strong | No visible |
| | | | | | fluorescence |
| | 48 | No visible | | | |
| | | fluorescence | | | |
| A(i) + B(ii) | 0 | Very strong | Very strong | Very strong | Very strong |
| | 1 | Very strong | Very strong | Very strong | Strong |
| | 6 | Barely visible | Strong | Strong | Barely visible |
| | 24 | No visible | No visible | No visible | No visible |
| | | fluorescence | fluorescence | fluorescence | fluorescence |
| A(ii) + B(i) | 0 | Very strong | Very strong | Very strong | Very strong |
| | 1 | Very strong | Very strong | Very strong | Very strong |
| | 6 | Very strong | Very strong | Very strong | Very strong |
| | 24 | Very strong | Very strong | Very strong | Strong |
| | 48 | Very strong | Very strong | Very strong | No visible |
| | | | | | fluorescence |
| | 72 | Faint | Strong | Very strong | |
| | 96 | Barely visible | Quite Strong | Strong | |
| A(ii) + B(ii) | 0 | Very strong | Very strong | Very strong | Very strong |
| | 1 | Very strong | Very strong | Very strong | Very strong |
| | 6 | Very strong | Very strong | Very strong | Strong |
| | 24 | Faint | Very strong | Very strong | No visible |
| | | | | | fluorescence |
| | 48 | No visible | No visible | Strong | |
| | | fluorescence | fluorescence | | |
| | 72 | | | Strong | |
| | 96 | | | Faint | |

Table 1 shows the disinfectants of the invention, which comprise a peracid, have sufficiently sustainable fluorescence, which decreases in fluorescence strength over time. In particular, Table 1 shows the influence of concentration and dilution conditions on the rate of decrease of fluorescence strength.

What is claimed is:

1. A process for the preparation of an aqueous ready-to-use disinfectant composition comprising the following successive steps:
1) (a) providing an aqueous preparation A comprising at least one peracid; and (b) providing a preparation B comprising at least one organic compound capable of showing fluorescence on UV irradiation; and
2) mixing the preparations A and B and, optionally, water,
wherein the composition of the preparations A and B and the mixing ratio used in step 2) is selected in such a manner that the resultant aqueous ready-to-use disinfectant composition comprises
0.005 to 5 wt. % of the at least one peracid, and
0.0001 to 3 wt. % of the at least one organic compound capable of showing fluorescence on UV irradiation.

2. The process of claim 1, wherein preparation A has a peracid content of above 1 to 5 wt. %, and wherein the dilution with water in step 2) is performed within 60 minutes after having mixed preparations A and B.

3. The process of claim 1 or 2, wherein preparation B is an aqueous preparation.

4. The process of claim 1, wherein preparation B comprises at least one surfactant C and wherein the resultant ready-to-use disinfectant composition comprises 0.001 to 30 wt. % of the at least one surfactant C.

5. The process of claim 4, wherein the at least one surfactant C is a high-foaming surfactant.

6. The process of claim 1, wherein the concentration of the at least one peracid is less than 3 wt. % within the aqueous preparation A prior to contacting it with the at least one organic compound capable of showing fluorescence on UV irradiation and wherein the content of the at least one peracid in the ready-to-use disinfectant composition is 0.005 to 1 wt. %.

7. The process of claim 1, wherein the aqueous preparation A is an aqueous preparation A1 comprising at least one peracid prepared by the addition of the at least one peracid or of a precursor for the at least one peracid to water and wherein the content of the at least one peracid in the ready-to-use disinfectant composition is 0.005 to 1 wt. %.

8. The process of claim 1, wherein the aqueous preparation A is an aqueous preparation A2 comprising hydrogen peroxide and at least one peracid prepared by in-situ generation of the at least one peracid from at least one precursor and at least one peroxide source.

9. The process of claim 1, wherein the aqueous preparation A is an aqueous preparation A3 comprising, in a chemical equilibrium with each other, hydrogen peroxide, at least one peracid and the corresponding at least one carboxylic acid and wherein the resultant aqueous ready-to-use disinfectant composition comprises 0.005 to 1 wt. % of the at least one peracid, 0.006 to 1.2 wt. % of the corresponding at least one carboxylic acid and 0.025 to 5 wt. % of hydrogen peroxide.

10. The process of claim 1, wherein the peracid is a C1-C9 peracid.

11. The process of claim 10, wherein the peracid is a C1-C3 peracid.

12. The process of claim 11, wherein the peracid is peracetic acid.

13. The process of claim 1, wherein mixing step 2) is performed no longer than 48 hours before application of the ready-to-use disinfectant composition.

14. A ready-to-use disinfectant composition prepared by the process of claim 1.

15. A disinfection method comprising using the ready-to-use disinfectant composition of claim 14.

16. The disinfection method of claim 15, wherein the ready-to-use disinfectant composition is applied to a surface to be disinfected and wherein during and/or after application of the ready-to-use disinfectant composition the surface to which the ready-to-use disinfectant composition has been applied is irradiated with UV light for monitoring purposes.
